(19) United States
(12) Patent Application Publication
(10) Pub. No.: US 2026/0303499 A1
(43) Pub. Date: Oct. 1, 2026

(54) System and method for network latency determination based on edge computing nodes

(71) Applicant: Bank of America Corporation, Charlotte, NC (US)

(72) Inventors: Vasudevan Atteeri, Thousand Oaks, CA (US); Naga Vamsi Krishna Akkapeddi, Charlotte, NC (US); Nagasubramanya Lakshminarayana, Concord, NC (US); Pushpanjali Kottapalli, Bridgewater, NJ (US); Matthew Sari Tarazi, New York City, NY (US); Jemlin Lucas, Coppell, TX (US)

(21) Appl. No.: 19/097,021

(22) Filed: Apr. 1, 2025

(51) Int. Cl. H04L 43/0852; H04L 41/16; H04L 43/0829; H04W 56/00

(52) U.S. Cl. CPC H04L 43/0852; H04L 41/16; H04L 43/0829; H04W 56/001

(57) ABSTRACT

A system for generating a transformed interaction request that includes a destination address corresponding with an edge application server. The system electronically receives a wireless interaction request initiated at the user device, which includes an interaction identifier. The system accesses, from memory, one or more request servicing stages required to complete the wireless interaction request initiated at the user device. The system determines if the wireless interaction request is a critical request based on the extracted interaction identifier and in response to determining that the wireless interaction request is the critical request based on the extracted interaction identifier. The system identifies an edge application server that performs one or more functions associated with the second application server and transforms the copy of the wireless interaction request to generate a transformed interaction request.

### TECHNICAL FIELD

The present disclosure relates generally to network communications and, more specifically, to a system and method for network latency determination based on edge computing nodes.

### BACKGROUND

In a network environment, user devices (e.g., a mobile phone) are used to communicate data with server devices. These network environments allow wireless interaction requests initiated at the user device to be transmitted to a server device (e.g., an application server device). As part of transmitting the wireless interaction requests to the server device, the wireless interaction request passes through multiple intermediate server devices. One of the technical challenges that occur when data is exchanged as part of transmitting the wireless interaction requests to the server device is transmitting the wireless interaction requests to an intermediate server device that may be unavailable (e.g., for system maintenance or device failure). When the intermediate server device is unavailable, the wireless interaction requests may be sent to the intermediate server device, but since the intermediate server device is unavailable, the wireless interaction request may never be received by the intermediate server device. This results in the wireless interaction request being lost. Existing systems are unable to provide reliable transmissions of the wireless interaction request to the server device.

### SUMMARY

The disclosed system, described in the present disclosure, is particularly integrated into a practical application for transmitting a wireless interaction request across multiple server devices. The disclosed system addresses technical problems rooted in network communications and achieves technical improvements to the network, the user devices and server devices used in network communications, and underlying computer systems that facilitate network communications between the user devices and server devices.

The system and method implemented by the system, as disclosed in the present disclosure, provide technical solutions to the technical problems discussed above by synchronizing a request tracking database to reflect the current status of one or more request servicing stages and generating a transformed interaction request when a wireless interaction request is lost.

Conventional technologies are not configured to provide reliable transmissions of a wireless interaction request to a server device. For example, data packets associated with wireless interaction requests may get lost due to variable delays introduced by network congestion. Further, the delayed transmission of data packets because of variable delays may result in delayed packet arrival times and out-of-order arrival of packets due to retransmission, which results in service interruptions of real-time applications (e.g., video streaming services). One of the technical challenges that may also occur when data is exchanged as part of transmitting the wireless interaction requests to the server device is transmitting the wireless interaction requests to a first intermediate server device that is unavailable (e.g., for system maintenance or device failure). When the first intermediate server device is unavailable, the wireless interaction request may never be received by the first intermediate server device. This results in the wireless interaction request being lost, and the jobs associated with the wireless interaction request may not be executed or completed.

For example, the jobs associated with the wireless interaction request may be batch-processing jobs to read and write data by connecting with a server device. When the wireless interaction request is lost it results in a failure to execute the batch processing jobs. Further, certain other computing systems may rely on the batch processing jobs to be executed. In such a situation, since the batch processing jobs are not executed, this may result in system damage (e.g., compromised computing performance, device failure, etc.) to those other computing systems in communication with the server device. To remedy such harmful actions (i.e., system damage), the affected computing systems must be taken offline until the root problem is identified, thus making it inaccessible until the problem is identified and remedied. When a computing system is taken offline, it may further cause the computing systems to shut down or go offline and thus be unavailable to provide services. This results in, for example, under-utilization of the affected computing systems, resulting in reduced performance of the network. In a situation where multiple computing systems may go offline; it may result in disruption of network operations across the network. In some cases, the disruption of network operations across a network is often associated with unnecessary data redundancy and thus reduces the overall network performance. Further, multiple computing systems go out of service, this results in increased downtime that further generates inaccurate network resource usage patterns, which results in inaccurate network resource allocation.

In some embodiments, a system for generating a transformed interaction request that includes a destination address corresponding with an edge application server includes a memory operably coupled with a processor. The memory is configured to store a request tracking database. The request tracking database stores a first status indicator associated with a first request servicing stage and a second status indicator associated with a second request servicing stage. The first request servicing stage and the second request servicing stage are used to complete a wireless interaction request. The processor is configured to electronically receive the wireless interaction request initiated at the user device and the wireless interaction request includes an interaction identifier. Processor is further configured to access, from the memory, one or more request servicing stages used to complete the wireless interaction request initiated at the user device. The one or more request servicing stages comprises the first request servicing stage and the second request servicing stage. The first request servicing stage includes a first application server to service the wireless interaction request and the second request servicing stage includes a second application server to service the wireless interaction request.

The processor is further configured to electronically transmit the wireless interaction request to the first request servicing stage to initiate servicing the wireless interaction request by the first application server and store a copy of the wireless interaction request in the request tracking database. Further, in conjunction with electronically transmitting the wireless interaction request to the first request servicing stage, synchronize the request tracking database to reflect a current status of the one or more request servicing stages by including a first service initiated status corresponding with the first status indicator of the first request servicing stage.

The processor is further configured to electronically receive a synchronization request, from the first application server, to synchronize the current status of the one or more request servicing stages of the request tracking database by updating the first service initiated status of the first status indicator to a first service completed status indicating servicing of the wireless interaction request is completed at the first request servicing stage by the first application server. Further includes a second service initiated status corresponding with the second status indicator of the second request servicing stage. The wireless interaction request is transmitted to the second request servicing stage in response to completing the servicing of the wireless interaction request at the first request servicing stage by the first application server.

The processor further determines if the wireless interaction request was transmitted successfully to the second application server associated with the second request servicing stage. Further, the processor extracts the interaction identifier from the copy of the wireless interaction request stored in the request tracking database in response to determining that the wireless interaction request was not transmitted successfully to the second application server. The processor further determines if the wireless interaction request is a critical request based on the extracted interaction identifier. The processor identifies a request servicing stage that includes a most recent service initiated status from the one or more request servicing stages, in response to determining that the wireless interaction request is the critical request based on the extracted interaction identifier. The second status indicator associated with the second request servicing stage includes the most recent service initiated status.

The processor identifies an edge application server that performs one or more functions associated with the second application server associated with the second request servicing stage, in response to identifying the second request servicing stage to include the most recent service initiated status. The processor modifies the copy of the wireless interaction request to include a destination address corresponding with the edge application server to generate a transformed interaction request. The processor electronically transmits the transformed interaction request to the edge application server and receives an interaction completed notification from the edge application server in response to electronically transmitting the transformed interaction request to the edge application server. The interaction completed notification indicates that the wireless interaction request initiated at the user device is completed.

Thus, unlike conventional systems that are unable to provide reliable transmissions of the wireless interaction request to the server device, the disclosed system and method for synchronizing a request tracking database to reflect the current status of one or more request servicing stages and generating a transformed interaction request that includes a destination address corresponding with an edge application server when a wireless interaction request is lost. As explained above, when a wireless interaction request is lost, it may cause system damage to those other computing systems in communication with the server device. To remedy such harmful actions (i.e., system damage), the affected computing systems must be taken offline until the root problem is identified, thus making it inaccessible until the problem is identified and remedied. When a computing system is taken offline, it may further cause the computing systems to shut down or go offline and thus be unavailable to provide services. This leads to increased system downtime and further requires additional resources to remediate the offline computing systems, which in turn interrupts other operations that utilize the additional resources.

By generating a transformed interaction request that includes a destination address corresponding with an edge application server and transmitting the transformed interaction request to the edge application server associated with the destination address, it allows execution of the batch jobs associated with the lost wireless interaction request, thereby reducing or eliminating system damage from occurring. Further, by utilizing edge application servers that are physically closer to the user devices, latency in the transmission of data to user devices is reduced, and this results in servicing of wireless interaction requests efficiently by reducing transmission delays. Additionally, reducing transmission delays avoids the out-of-order arrival of data packets due to retransmission, which in turn reduces service interruptions of real-time applications (e.g., video streaming services). Further, the system mitigates the above-described harmful actions that may otherwise occur to the other computing systems in communication with the server device, thus saving downtime associated with affected computing systems and additionally saving resources that would otherwise be necessary to remediate affected computing systems, which in turn provides uninterrupted operations of the network. This leads to improved operational efficiency of computing systems because the computing systems are not required to be taken offline for remediation.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of embodiments of the disclosure and the potential advantages thereof, reference is now made to the following written description taken in conjunction with the accompanying drawings in which:

FIG. 1 is a schematic diagram of a system, in accordance with an embodiment of the present disclosure; and

FIGS. 2A-2B illustrates an example flowchart of a method of the system of FIG. 1 for synchronizing a request tracking database and generating a transformed interaction request.

### DETAILED DESCRIPTION

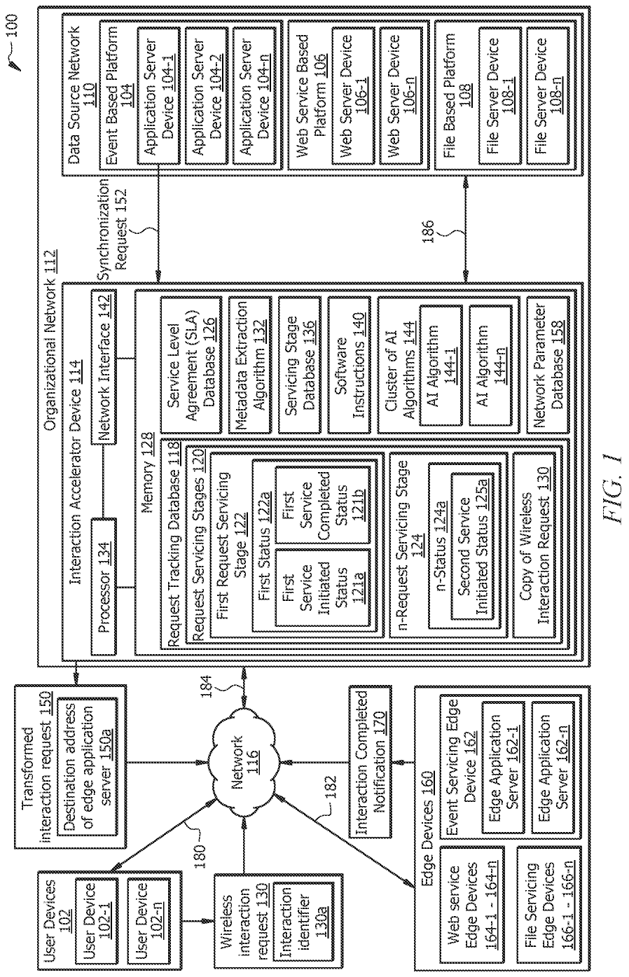

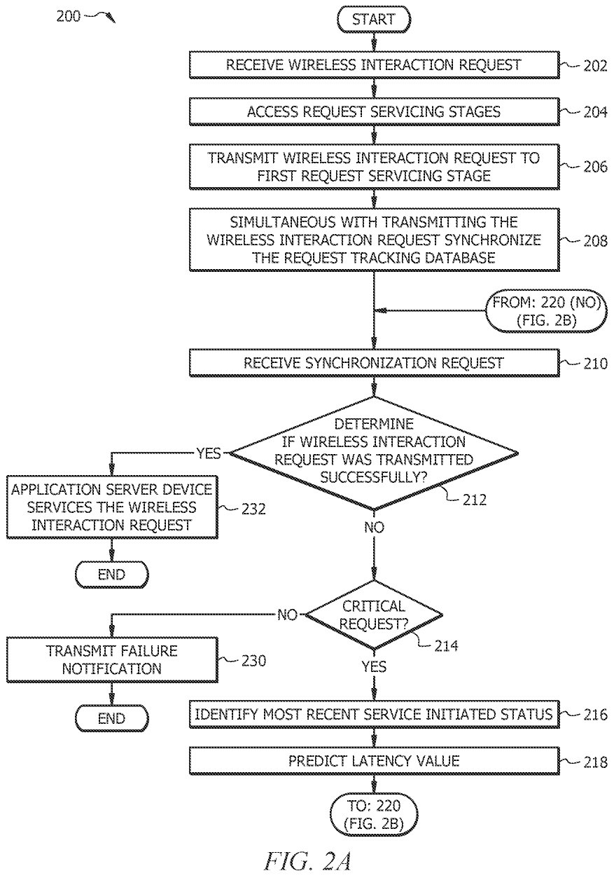

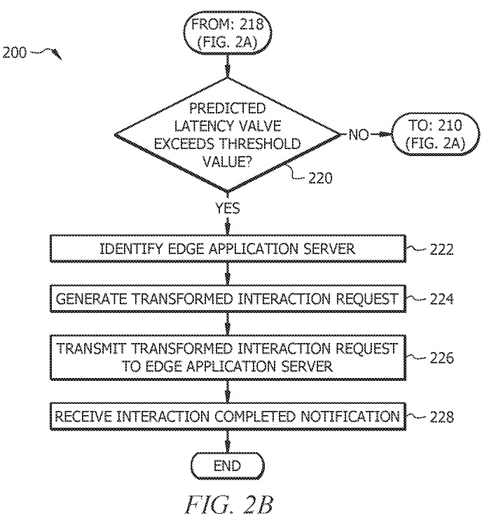

As described above, conventional technologies fail to provide secure communication between user devices and server devices. Embodiments of the present disclosure and its advantages may be understood by referring to FIGS. 1-2B. FIGS. 1-2B is used to describe systems and methods for synchronizing a request tracking database and generating a transformed interaction request, according to some embodiments.

### System Overview

FIG. 1 is a schematic diagram of a system 100, in accordance with certain embodiments of the present disclosure. As shown, system 100 includes user devices 102-1 to 102-n, a data source network 110 (including application server devices 104-1 to 104-n), interaction accelerator device 114, and edge devices 160 operably connected to one another via a network 116. Network 116 enables communication among the components of the system 100. The user devices 102-1 to 102-n are collectively or individually referred to as user device 102. In general, system 100 synchronizes a request tracking database 118 to reflect a current status (e.g., first status 122a) associated with a first request servicing stage 122 and generates a transformed interaction request 150 when a wireless interaction request 130 is lost.

In general, system 100 electronically transmits a wireless interaction request 130 to an application server device 104-1 to initiate servicing the wireless interaction request 130. Further, system 100 determines if the wireless interaction request 130 is lost based on determining if the wireless interaction request 130 was successfully transmitted to an application server device 104-n. When system 100 determines that the wireless interaction request 130 was not successfully transmitted to the application server device 104-n, the system predicts/estimates a latency value associated with transmitting the wireless interaction request 130 to the application server device 104-n based on network parameters stored in a network parameter database 158 associated with the application server device 104-n of the n-request servicing stage 124. Further, when system 100 determines that the estimated latency value exceeds the threshold network latency value, then system 100 generates a transformed interaction request 150. The transformed interaction request 150 is a modified version of the wireless interaction request 130. This transformed interaction request 150 is then transmitted to an edge application server 162-n for servicing.

### SYSTEM COMPONENTS

### User Devices

System 100 includes user devices 102-1 to 102-n, these are collectively referred to as user devices 102. The user devices 102-1 to 102-n may generally be any device configured to process data. User devices 102-1 to 102-n may also include, but are not limited to, a smartwatch, a personal computer, a desktop computer, a workstation, a server, a laptop, a tablet computer, a mobile phone (such as a smartphone), an Internet-of-Things (IoT) device, a wearable computing device, smart glasses or bracelets, phablets, other smart devices, devices configured for wired or wireless RF (Radio Frequency) communication, or any other suitable type of device. The user devices 102-1 to 102-n may also include a display, a microphone, a camera, a keypad, or other appropriate equipment usable by a user. User devices 102-1 to 102-n are utilized to transmit a wireless interaction request to application server devices 104-1 to 104-n via the interaction accelerator device 114.

### Data Source Network

As shown in FIG. 1, data source network 110 may include but is not limited to, application server devices 104-1 to 104-n, web server devices 106-1 to 106-n, and file server devices 108-1 to 108n. The application server devices 104-1 to 104-n together are part of an event-based platform 104. The web server devices 106-1 to 106-n are part of a web service-based platform 106. Further, the file server devices 108-1 to 108n are part of a file-based platform 108. The application server devices 104-1 to 104-n, web server devices 106-1 to 106-n, and file server devices 108-1 to 108-n is a computer that is configured to perform one or more tasks (e.g., batch jobs) associated with a wireless interaction request 130 received from user devices 102. The one or more tasks performed may include data transfer between user accounts, access data from user accounts, and/or any other tasks may be included. In one or more embodiments, data source network 110 may be a group of cloud server devices (not shown).

### Interaction Accelerator Device

The interaction accelerator device 114 includes a processor 134 in signal communication with a memory 128. Memory 128 stores software instructions 140 that, when executed by processor 134, cause processor 134 to perform one or more operations of the interaction accelerator device 114 described herein. The interaction accelerator device 114 further includes a network interface 142. The interaction accelerator device 114 communicates with data source network 110 over the communication link 186.

### Processor

Processor 134 includes one or more processors. Processor 134 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors are configured to execute instructions (e.g., software instructions 140) to perform the operations of the interaction accelerator device 114 described herein. The processor 134 is configured to operate as described in FIGS. 1-2B. For example, the processor 134 may be configured to perform one or more operations of the method 200 as described in FIGS. 2A-2B.

### Network Interface

Network interface 142 is configured to enable wired and/or wireless communications. The network interface 142 may be configured to communicate data between the interaction accelerator device 114 and other devices, systems, or domains. The processor 134 may be configured to send and receive data using the network interface 142. The network interface 142 may be configured to use any suitable type of communication protocol.

### Memory

The memory 128 may be volatile or non-volatile and may comprise read-only memory (ROM), random-access memory (RAM), ternary content-addressable memory (TCAM), dynamic random-access memory (DRAM), and static random-access memory (SRAM). The memory 128 may include one or more of a local database, a cloud database, a network-attached storage (NAS), etc. The memory 128 comprises one or more disks, tape drives, or solid-state drives, and may be used as an over-flow data storage device, to store programs when such programs are selected for execution, and to store instructions and data that are read during program execution. Memory 128 may store any of the information described in FIGS. 1-2B along with any other data, instructions, logic, rules, or code operable to implement the function(s) described herein when executed by processor 134. For example, the memory 128 may store a request tracking database 118, a service level agreement (SLA) database 126, a metadata extraction algorithm 132, a servicing stage database 136, software instructions 140, a cluster of artificial intelligence (AI) algorithms 144, and/or any other data or instructions. The software instructions 140 may include any suitable set of instructions, logic, rules, or code operable to execute the processor 134 and perform the functions described herein, such as some or all of those described in FIGS. 1-2B.

### Network

Network 116 may be any suitable type of wireless and/or wired network. The network 116 may be connected to the Internet or public network. Network 116 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wireless Fidelity (WiFi®), Wireless Gigabit (WiGig®), Worldwide Interoperability for Microwave Access (WiMAX®), etc.), a long-term evolution (LTE) network, a universal mobile telecommunications system (UMTS) network, a peer-to-peer (P2P) network, a Bluetooth® network, a near-field communication (NFC) network, and/or any other suitable network. The network 116 may be configured to support any suitable type of communication protocol, as would be appreciated by one of ordinary skills in the art. The network 116 communicates with user devices 102 over the communication link 180. Network 116 communicates with the organizational network 112 over the communication link 184. Further, network 116 communicates with edge devices 160 over the communication link 182.

### Organizational Network

The organizational network 112 includes interaction accelerator device 114 and data source network 110. The organizational network 112 is in communication with user devices 102 and edge devices 160 via network 116. In some embodiments, the organizational network 112 may be an internal network of the organization and may include all or a portion of a private data network, a local area network (LAN), a metropolitan area network (MAN), a wide area network (WAN), a local or regional communication or computer network, wireline or wireless network, an enterprise intranet, or any other suitable communication link, including combinations thereof, operable to facilitate communication between interaction accelerator device 114 and data source network 110. In some embodiments, the edge devices 160 may be included within the organizational network 112.

### Receive Wireless Interaction Request

In an embodiment, processor 134 of interaction accelerator device 114 electronically receives a wireless interaction request 130 from the user device 102-1. The wireless interaction request 130 includes an interaction identifier 130a. The wireless interaction request 130 initiated at the user device 102-1 may include a user interacting with user device 102-1 to perform account operations. For example, the wireless interaction request 130 may be a user account-related operation, which includes initiating a transfer of a data value from a first account identifier (e.g., account ABC) stored on an application server device 104-1 to a second account identifier (e.g., account XYZ) stored on an application server device 104-n. This operation may be assigned an interaction identifier 130a of “transfer” by the processor 134. Another example of account operations may include initiating an update of address information associated with an account stored on an application server device 104-n. This operation may be assigned an interaction identifier 130a of “update” by the processor 134. However, any other operation related to an account may also be included as part of the wireless interaction request 130. The interaction identifier 130a indicates an identifier of the wireless interaction request 130.

### Access Request Servicing Stage

In response to receiving the wireless interaction request 130, processor 134 applies a metadata extraction algorithm 132 to the wireless interaction request 130 to extract the interaction identifier 130a. For example, the wireless interaction request 130 may be a JavaScript Object Notation (JSON) file, and the metadata extraction algorithm 132 may be a JSON extraction algorithm. For example, the wireless interaction request 130 is a request to transfer a data value from a first account to a second account. Processor 134 extracts the first account identifier, the second account identifier, and the interaction identifier 130a to determine one or more servicing stages required to complete the wireless interaction request 130.

Based on extracting the first account identifier, processor 134 accesses the servicing stage database 136 (stored in memory 128) to determine a first request servicing stage 122 and n-request servicing stage 124. Specifically, processor 134 accesses the servicing stage database 136 (stored in memory 128) and determines the storage location of account information associated with the first account identifier. A servicing stage database 136 stores account information locations associated with account identifiers. For example, the servicing stage database 136 stores account information associated with the first account identifier stored at application server device 104-1, and further stores account information associated with the second account identifier stored at application server device 104-n.

Processor 134 accesses the servicing stage database 136 and determines that the account information associated with the first account identifier is stored at application server device 104-1. Thus, the first request servicing stage 122 is to transmit the wireless interaction request 130 to the application server device 104-1. Next, for the second account identifier, processor 134 determines that the account information associated with second account identifier is stored at application server device 104-n, thus the second request servicing stage is to transmit the wireless interaction request 130 to application server device 104-n. Accordingly, in this embodiment the one or more servicing stages are associated with event-based platform 104 and the one or more servicing stages indicate a route (e.g., first to application server device 104-1 and then to application server device 104-n) through which the wireless interaction request 130 is transmitted to complete the wireless interaction request 130 initiated at user device 102-1. Although this example shows the route taken to be first at application server device 104-1 and then to application server device 104-n, in another example, the route taken may include multiple other application server devices (e.g., application server device 104-2) in between the first at application server device 104-1 and then to application server device 104-n.

In an embodiment, similar to the event-based platform 104, the wireless interaction request 130 may be associated with the web service-based platform 106. For example, one or more servicing stages are associated with web service-based platform 106 and one or more servicing stages indicate a route (e.g., first to web server device 106-1 and then to web server device 106-n) through which the wireless interaction request 130 is transmitted to complete the wireless interaction request 130 initiated at user device 102-1. Thus, the first request servicing stage 122 includes a web server device 106-1 to service the wireless interaction request 130, and the n-request servicing stage 124 includes a web server device 106-n to service the wireless interaction request 130.

In an embodiment, similar to the event-based platform 104, the wireless interaction request 130 may be associated with file-based platform 108. For example, one or more servicing stages are associated with file-based platform 108 and one or more servicing stages indicate a route (e.g., first to file server device 108-1 and then to file server device 108-n) through which the wireless interaction request 130 is transmitted to complete the wireless interaction request 130 initiated at user device 102-1. Thus, the first request servicing stage 122 includes file server device 108-1 to service the wireless interaction request 130 and the n-request servicing stage 124 includes a file server device 108-n to service the wireless interaction request 130.

### Transmit Wireless Interaction Request to First Request Servicing Stage

Processor 134 of interaction accelerator device 114 electronically transmits the wireless interaction request 130 to the first request servicing stage 122 (i.e., to application server device 104-1) to initiate servicing the wireless interaction request 130 by the application server device 104-1 and stores a copy of the wireless interaction request 130 in the request tracking database 118.

### Synchronize Request Tracking Database

Processor 134 of interaction accelerator device 114, simultaneous with electronically transmitting the wireless interaction request 130 to the first request servicing stage 122 (i.e., to the application server device 104-1), processor 134 synchronizes the request tracking database 118. Further, in conjunction with electronically transmitting the wireless interaction request 130 to the first request servicing stage 122 (i.e., to the application server device 104-1), processor 134 synchronizes the request tracking database 118 to reflect a current status of the request servicing stages 120 by including a first service-initiated status 121a corresponding with the first status 122a of the first request servicing stage 122.

### Request Tracking Database

The request tracking database 118 stores the request servicing stages 120. The request servicing stages 120 includes a first request servicing stage 122 and n-request servicing stage 124. The first request servicing stage 122 indicates the status (e.g., first status 122a) of the wireless interaction request 130 while being serviced at the first request servicing stage 122 by the application server device 104-1. The n-request servicing stage 124 indicates the status (e.g., n-status 124a) of the wireless interaction request 130 while being serviced at the n-request servicing stage 124 by the application server device 104-n.

As part of synchronizing the request tracking database 118, processor 134 updates a first status 122a in the first request servicing stage 122 to reflect the current status of the wireless interaction request 130 at the application server device 104-1. For example, upon transmitting the wireless interaction request 130 to the application server device 104-1, processor 134 updates the first status 122a to include a first service-initiated status 121a, to indicate that the wireless interaction request 130 is being serviced at the application server device 104-1. Further, processor 134 also stores a copy of the wireless interaction request 130 in the request tracking database 118. For example, as part of serving the wireless interaction request 130, the application server device 104-1 accesses account information (e.g., data value to be transferred) associated with the first account identifier to initiate a transfer of a data value from a first account identifier (e.g., account ABC) stored on an application server device 104-1 to a second account identifier (e.g., account XYZ) stored on an application server device 104-n.

### Receive a Synchronization Request

Processor 134 of interaction accelerator device 114 electronically receives a synchronization request 152 from the application server device 104-1. The synchronization request 152 is a request to synchronize the request tracking database 118 to update the first status 122a of the first request servicing stage 122 from first service initiated status 121a to first service completed status 121b. The first service completed status 121b indicates that the servicing of the wireless interaction request 130 is completed at the first request servicing stage 122 by the application server device 104-1. Upon completion of servicing of the wireless interaction request 130 by the application server device 104-1, the application server device 104-1 transmits the wireless interaction request 130 to the n- request servicing stage 124 (also interchangeably referred to as a second request servicing stage). This transmission of the wireless interaction request 130 to the n-request servicing stage 124 is indicated in the synchronization request 152. Accordingly, processor 134, upon receiving the synchronization request 152, synchronizes the request tracking database 118 to update the n-status 124a corresponding with the n-request servicing stage 124 to second service-initiated status 125a.

Processor 134 electronically receives the synchronization request 152 from the application server device 104-1 to synchronize the current status of the request servicing stages 120 of the request tracking database 118 by updating the first status 122a from first service-initiated status to first service completed status 121b indicating servicing of the wireless interaction request 130 is completed at the first request servicing stage 122 by the application server device 104-1. Further, processor 134 also includes a second service-initiated status 125a corresponding with the n-status 124a of n-request servicing stage 124.

In an embodiment, upon the completion of the first request servicing stage 122 by the application server device 104-1, the wireless interaction request 130 may be sent back to the interaction accelerator device 114. The processor 134 is then configured to electronically transmit the wireless interaction request 130 to the n-request servicing stage 124 (i.e., to application server device 104-n) to initiate servicing the wireless interaction request 130 by the application server device 104-n. Further, processor 134 synchronizes the request tracking database 118 to update the first status 122a of the first request servicing stage 122 from first service initiated status 121a to first service completed status 121b and further also updates the n-status 124acorresponding with the n-request servicing stage 124 to second service initiated status 125a.

### Determine If Wireless Interaction Request is Lost

Upon synchronizing the request tracking database 118, processor 134 of interaction accelerator device 114 determines if another synchronization request is received from the application server device 104-n within a threshold time period. For example, the threshold time period may be predefined within the SLA database 126. The threshold time period corresponds to the interaction identifier 130a included in the copy of the wireless interaction request 130 stored in the request tracking database 118. For example, the SLA database 126 stores a threshold time period of 2 seconds for interaction identifier 130a of “transfer” and a threshold time period of 10 minutes for interaction identifier 130a of “update”, although any other time period may also be associated with the interaction identifier 130a.

Upon determining that another synchronization request is not received from the application server device 104-n within the threshold time period, then processor 134 determines if the wireless interaction request 130 was transmitted successfully to the application server device 104-n associated with the n-request servicing stage 124. To determine if the wireless interaction request 130 was transmitted successfully to the application server device 104-n, processor 134 transmits a ping request to the application server device 104-n to determine whether the application server device 104-n is available and functioning normally. In this context, a “ping” may be a software utility that is used to test the reachability of a device (e.g., application server device 104-n) in a network (e.g., network 116). Processor 134 may be configured to determine that the application server device 104-n or a portion thereof is unavailable and/or out of service (e.g., due to power failure or system maintenance) in response to not receiving a response to one or more ping requests transmitted to the application server device 104-n. In response to determining that the application server device 104-n is unavailable and/or out of service, then processor 134 determines that the wireless interaction request 130 was not transmitted successfully to the application server device 104-n. Further, when the wireless interaction request 130 is not transmitted successfully to the application server device 104-n, processor 134 determines that the wireless interaction request 130 is lost.

In an embodiment, when the application server device 104-n receives a response to the ping request, then the processor 134 accesses the copy of the wireless interaction request 130 stored in the request tracking database 118 and transmits it to the application server device 104-n. Upon transmitting the copy of the wireless interaction request 130 to the application server device 104-n, processor 134 determines if another synchronization request is received from the application server device 104-n within a threshold time period. If another synchronization request is not received within the threshold time period, then processor 134 determines that the wireless interaction request 130 was not transmitted successfully to the application server device 104-n.

### Determine if Wireless Interaction Request is a Critical Request

In response to determining that the wireless interaction request 130 was not transmitted successfully to the application server device 104-n, processor 134 determines if the wireless interaction request 130 is a critical request. Processor 134 applies the metadata extraction algorithm 132 (e.g., JSON extraction algorithm) to the copy of the wireless interaction request 130 stored in the request tracking database 118 to extract the interaction identifier 130a. Upon extracting the interaction identifier 130a, processor 134 is configured to determine if the interaction identifier 130a is associated with a critical request or non-critical request. For example, if the interaction identifier 130a is “transfer”, then processor 134 determines that the wireless interaction request 130 is a critical request. In another example, if the interaction identifier 130a is “update”, then processor 134 determines that the wireless interaction request 130 is a non-critical request.

In an embodiment, AI algorithm 144-1 may be trained to determine if the wireless interaction request 130 is a critical request or a non-critical request.

### Cluster of AI Algorithms

The cluster of AI algorithms 144 may include a plurality of AI algorithms 144-1 to 144-n. The cluster of AI algorithms 144 may include a support vector machine, machine learning, neural network, random forest, a large language model (LLM) algorithm, deep learning algorithm, k-means clustering, Tree-based algorithm, Random Forest algorithm, convolutional neural network (CNN), deep neural network (DNN), recurrent neural network (RNN), Naïve Bayes classification, etc. In some embodiments, the AI algorithm 144-1 may include a data processing machine learning algorithm that is configured to determine if a wireless interaction request 130 is a critical request or a non-critical request. In some embodiments, the AI algorithm 144-n may include a data processing machine learning algorithm that is configured to estimate/predict a latency value associated with application server devices 104-1 to 104-n servicing the wireless interaction request 130. The cluster of AI algorithms 144 may be implemented by supervised, semi-supervised, and/or unsupervised machine learning. Further, each of the AI algorithms 144-1 to 144-n in the cluster of AI algorithms 144 are configured to interchangeably perform operations of each other, for example, AI algorithm 144-1 is configured to perform the operations of AI algorithm 144-n and similarly, AI algorithm 144-n is configured to perform the operations of AI algorithm 144-1.

### AI Algorithm 144-1

Specifically, AI algorithm 144-1 is trained based on two sets of training data. The first set of training data includes data labeled with critical request tags (i.e., wireless interaction requests are labeled as critical requests), and the second set of training data includes data labeled with non-critical request tags (i.e., wireless interaction requests are labeled as non-critical requests). The AI algorithm 144-1 is thus trained to distinguish and identify critical requests tags from non-critical request tags based on the two sets of training data. Additionally, the first set of training data may be labeled based on the interaction identifier 130a (e.g., “transfer”), such that AI algorithm 144-1 is trained to distinguish the interaction identifier 130a with “transfer” as belonging to critical request tags. In an embodiment, the second set of training data may be labeled based on the interaction identifier 130a (e.g., “update”), such that AI algorithm 144-1 is trained to distinguish the interaction identifier 130a with “update” as belonging to non-critical request tags. Thus, the AI algorithm 144-1 is trained to distinguish and identify critical requests and non-critical requests based on critical requests tags and non-critical request tags, respectively.

### Identify a Most Recent Service-Initiated Status

In response to determining that the wireless interaction request 130 is a critical request, processor 134 identifies a request servicing stage (e.g., n-request servicing stage 124) that includes a most recent service-initiated status (e.g., n-status 124a with second service initiate status 125a) from the request servicing stages 120. For example, upon the processor 134 receives the synchronization request 152 (as explained above), processor 134 synchronizes the request tracking database 118 to update the n-status 124a corresponding with the n-request servicing stage 124 to second service-initiated status 125a. Since the wireless interaction request 130 is determined to be lost after the n-status 124a is updated to second service-initiated status 125a, thus n-status 124a is determined as the most recent service-initiated status included in the n-request servicing stage 124.

### Predict a Latency Value

Upon determining that the n-request servicing stage 124 includes n-status 124a as the most recent second service-initiated status 125a, processor 134 predicts/estimate a latency value associated with the wireless interaction request 130 based on network parameters stored in a network parameter database 158 associated with the application server device 104-n of the n-request servicing stage 124. Latency value is measured by the time (in seconds) it takes for data to travel from one point to another on a network. Specifically, processor 134 predicts/estimates a latency value associated with transmitting the wireless interaction request 130 to the application server device 104-n based on network parameters stored in a network parameter database 158 associated with the application server device 104-n of the n-request servicing stage 124.

The processor 134 predicts the latency value based on accessing the network parameter database 158, which stores a plurality of network parameters. The plurality of network parameters includes a threshold downtime, network congestion capacity, and/or packet loss rate. For example, the threshold downtime indicates a maximum time period for which the application server device 104-n may be unavailable (e.g., for system maintenance or software updates). The network congestion capacity indicates the maximum amount of traffic the application server device 104-n may service. The packet loss rate indicates the percentage of data packet requests (e.g., wireless interaction request 130) that fail to reach the application server device 104-n. Based on accessing the network parameters stored at the network parameter database 158 the processor 134 is able to estimate the latency value associated with application server device 104-n. For example, the threshold downtime indicates that the application server device 104-n will be unavailable for a maximum of 5 minutes. Then, the processor 134 estimates the latency value associated with application server device 104-n is 5 minutes.

### AI Algorithm 144-n

In an embodiment, AI algorithm 144-n predicts the latency values. Processor 134 executes an AI algorithm 144-n to predict/estimate a latency value associated with the wireless interaction request 130 based on network parameters stored in a network parameter database 158 associated with the application server device 104-n of the n-request servicing stage 124. For example, the AI algorithm 144-n is trained using two data sets. The first data set is collected from the network parameter database 158 and includes a dataset of plurality of network parameters associated with application server devices 104-1 to 104-n. The plurality of network parameters includes a threshold downtime, network congestion capacity, and/or packet loss rate, although any other network-related parameter may also be included. Annotations are applied to each of the plurality of network parameters included in the first data set. The annotations indicate a latency value associated with each of the network parameters. For example, an annotation associated with the threshold downtime indicates a latency value of 5 minutes associated with the application server device 104-n. A first training set is created, which includes the annotated network parameters and non-annotated network parameters. The AI algorithm 144-n is trained using the first training set to identify a latency value associated with each of the network parameters associated with the application server devices 104-1 to 104-n. A second training set is created for a second stage of training comprising the first training set and those network parameters that are identified to include incorrect latency values. The AI algorithm 144-n is re-trained in a second stage using the second training set to generate a trained AI algorithm 144-n.

### Compare the Latency Value with a Threshold Value

Next, processor 134 compares the estimated latency value (e.g., 5 minutes) associated with application server device 104-n with a threshold network latency value associated with the interaction identifier 130a of the wireless interaction request 130 stored in the SLA database 126. The SLA database 126 stores a threshold network latency value associated with the interaction identifier 130a. For example, if the interaction identifier 130a is “transfer,” then the threshold network latency value is 3 minutes. In another example, if the interaction identifier 130a is “update,” then the threshold network latency value is 20 minutes.

Accordingly, in an embodiment, when the interaction identifier 130a is “transfer,” then the threshold network latency value is 3 minutes. Processor 134 compares the estimated latency value (e.g., 5 minutes) associated with application server device 104-n with a threshold network latency value (e.g., 3 minutes) associated with the interaction identifier 130a of “transfer.” In this embodiment, processor 134 determines that the estimated latency value (e.g., 5 minutes) exceeds the threshold network latency value (e.g., 3 minutes). In response to determining that the estimated latency value exceeds the threshold network latency value, then processor 134 accesses edge device 160 to determine which of the edge application servers 162-1 to 162-n performs one or more functions associated with the application server device 104-n (i.e., unavailable) of the n-request servicing stage 124.

### Identify Edge Application Server

Processor 134 is configured to identify which of the edge devices 160 performs one or more functions associated with the application server device 104-n. The edge devices 160 include edge application servers 162-1 to 162-n, web service edge devices 164-1 to 164-n, and file servicing edge devices 166-1 to 166-n. Edge application servers 162-1 to 162-n together are referred to as event servicing edge device 162. For example, edge application servers 162-1 to 162-n are configured as backup servers for the application server devices 104-1 to 104-n, respectively. Account information stored at each of the edge application servers 162-1 to 162-n is the same as that of the corresponding application server devices 104-1 to 104-n. For example, account information stored at edge application server 162-n is the same as that of the corresponding application server device 104-n. Thus, the second account identifier (e.g., account XYZ) stored on an application server device 104-n is also stored on the edge application server 162-n.

Further, each of the edge application servers 162-1 to 162-n are configured with the hardware configurations (e.g., memory storage, processor) such that the operations performed by each of the application server devices 104-1 to 104-n can be performed by the corresponding edge application servers 162-1 to 162-n. For example, operations performed by application server device 104-n can be performed by corresponding edge application server 162-n.

Accordingly, processor 134 identifies edge application server 162-n from the edge application servers 162-1 to 162-n as being configured to perform operations associated with the application server device 104-n (i.e., unavailable).

Edge devices 160 may be located at a geo-location that is closer to the user devices 102. Since edge devices 160 are located geographically closer to the user devices 102 in comparison to the data source network 110 (e.g., application server devices 104-1 to 104-n) that may be located at another geolocation further away from the user devices 102, this reduces latency in the transmission of data from edge devices 160 to user devices 102.

### Generate a Transformed Interaction Request

Next, processor 134 modifies the copy of the wireless interaction request 130 stored in the request tracking database 118 to include a destination address 150a corresponding with edge application server 162-n to generate a transformed interaction request 150. The transformed interaction request 150 is a modified version of the wireless interaction request 130, such that the transformed interaction request 150 includes a destination address 150a corresponding to the edge application server 162-n. The transformed interaction request 150 includes the information associated with the wireless interaction request 130 and also includes the destination address 150a corresponding to the edge application server 162-n.

### Transmit to Edge Devices

Processor 134 then transmits the transformed interaction request 150 to the edge application server 162-n based on the destination address 150a corresponding to the edge application server 162-n. Processor 134 determines the destination address 150a corresponding to the edge application server 162-n included in the transformed interaction request 150 and transmits the transformed interaction request 150 to the edge application server 162-n corresponding to the destination address 150a.

In response to electronically transmitting the transformed interaction request 150 to the edge application server 162-n, processor 134 receives an interaction completed notification 170 from the edge application server 162-n. The interaction completed notification 170 indicates that the wireless interaction request 130 initiated at the user device 102-1 is completed. Thus, the transfer of the data value from a first account identifier (e.g., account ABC) stored on an application server device 104-1 to a second account identifier (e.g., account XYZ) stored on an edge application server 162-n is completed.

FIGS. 2A-2B illustrates an example flowchart of method 200 for generating a transformed interaction request 150 that includes a destination address 150a corresponding with an edge application server 162-n when a wireless interaction request 130 is lost, in accordance with an embodiment of the present disclosure. For example, one or more operations of method 200 may be implemented, at least in part, in the form of software instructions 140 of FIG. 1, stored on a tangible non-transitory machine-readable medium or a computer-readable medium (e.g., memory 128 of FIG. 1) that, when run by one or more processors (e.g., processor 134 of FIG. 1) may cause the one or more processors to perform operations of the method 200.

Referring to FIG. 2A, at operation 202, processor 134 of interaction accelerator device 114 electronically receives a wireless interaction request 130 from the user device 102-1.

At operation 204, processor 134 accesses the servicing stage database 136 to determine one or more servicing stages (e.g., first request servicing stage 122 & n-request servicing stage 124) required to complete the wireless interaction request 130.

At operation 206, processor 134 of interaction accelerator device 114 electronically transmits the wireless interaction request 130 to the first request servicing stage 122 (i.e., to the application server device 104-1).

At operation 208, processor 134 simultaneous with the transmission of the wireless interaction request 130 to the first request servicing stage 122 (i.e., to the application server device 104-1), processor 134 synchronizes the request tracking database 118. At operation 210, processor 134 electronically receives a synchronization request 152 from the application server device 104-1.

At operation 212, processor 134 determines if the wireless interaction request 130 was not transmitted successfully to the application server device 104-n. In response to determining that the wireless interaction request 130 was not transmitted successfully to the application server device 104-n, the method proceeds to operation 214. At operation 214, processor 134 determines if the wireless interaction request 130 is a critical request. In response to determining that the wireless interaction request 130 is a critical request, the method proceeds to operation 216.

At operation 216, processor 134 identifies a request servicing stage (e.g., n-request servicing stage 124) that includes a most recent service-initiated status (e.g., n-status 124a) from the request servicing stages 120.

At operation 218, processor 134 executes an AI algorithm 144-1 to predict a latency value associated with the wireless interaction request 130.

At operation 220, with respect to FIG. 2B, processor 134 compares the estimated latency value (e.g., 5 minutes) associated with application server device 104-n with a threshold network latency value (e.g., 3 minutes) associated with the interaction identifier 130a of “transfer.” Based on the comparison, if the estimated latency value exceeds the threshold network latency value, then method proceeds to operation 222.

At operation 222, processor 134 identifies which of the edge application servers 162-1 to 162-n performs one or more functions associated with the application server device 104-n.

At operation 224, processor 134 transforms the copy of the wireless interaction request 130 stored in the request tracking database 118 to generate a transformed interaction request 150.

At operation 226, processor 134 transmits the transformed interaction request 150 to the edge application server 162-n.

At operation 228, processor 134 receives an interaction completed notification 170 from the edge application server 162-n.

Back at operation 220, based on the comparison, if the estimated latency value does not exceed the threshold network latency value, then method loops back to operation 210.

Back at operation 214, in response to determining that the wireless interaction request 130 is not a critical request, the method proceeds to operation 230.

At operation 230, processor 134 electronically transmits an interaction failure notification to the user device 102-1. The interaction failure notification indicates to the user device 102-1 that the wireless interaction request 130 is not completed and has failed.

Back at operation 212, in response to determining that the wireless interaction request 130 was transmitted successfully to the application server device 104-n, then the method proceeds to operation 232. At operation 232, the application server device 104-n services the wireless interaction request 130 and completes the interaction initiated at user device 102-1.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

What is claimed is:

1. A system comprising:
a memory operable to store a request tracking database, the request tracking database stores a first status indicator associated with a first request servicing stage and a second status indicator associated with a second request servicing stage, wherein the first request servicing stage and the second request servicing stage are used to complete a wireless interaction request; and
a processor operably coupled to the memory and configured to:
electronically receive, from a user device, the wireless interaction request initiated at the user device, wherein the wireless interaction request includes an interaction identifier;
access, from the memory, one or more request servicing stages used to complete the wireless interaction request initiated at the user device, wherein the one or more request servicing stages comprises the first request servicing stage and the second request servicing stage, and wherein the first request servicing stage includes a first application server to service the wireless interaction request and the second request servicing stage includes a second application server to service the wireless interaction request;
electronically transmit the wireless interaction request to the first request servicing stage to initiate servicing the wireless interaction request by the first application server and store a copy of the wireless interaction request in the request tracking database;
in conjunction with electronically transmitting the wireless interaction request to the first request servicing stage, synchronize the request tracking database to reflect a current status of the one or more request servicing stages by including a first service initiated status corresponding with the first status indicator of the first request servicing stage;
electronically receive a synchronization request, from the first application server, to synchronize the current status of the one or more request servicing stages of the request tracking database by updating the first service initiated status of the first status indicator to a first service completed status indicating servicing of the wireless interaction request is completed at the first request servicing stage by the first application server, and by including a second service initiated status corresponding with the second status indicator of the second request servicing stage, wherein the wireless interaction request is transmitted to the second request servicing stage in response to completing the servicing of the wireless interaction request at the first request servicing stage by the first application server;
determine if the wireless interaction request was transmitted successfully to the second application server associated with the second request servicing stage;
in response to determining that the wireless interaction request was not transmitted successfully to the second application server, extract the interaction identifier from the copy of the wireless interaction request stored in the request tracking database;
determine if the wireless interaction request is a critical request based on the extracted interaction identifier;
in response to determining that the wireless interaction request is the critical request based on the extracted interaction identifier, identify a request servicing stage that includes a most recent service initiated status from the one or more request servicing stages, wherein the second status indicator associated with the second request servicing stage includes the most recent service initiated status;
in response to identifying the second request servicing stage to include the most recent service initiated status, identify an edge application server that performs one or more functions associated with the second application server associated with the second request servicing stage;
modify the copy of the wireless interaction request to include a destination address corresponding with the edge application server to generate a transformed interaction request;
electronically transmit the transformed interaction request to the edge application server; and
in response to electronically transmitting the transformed interaction request to the edge application server, receive an interaction completed notification from the edge application server, wherein the interaction completed notification indicates that the wireless interaction request initiated at the user device is completed.

2. The system of claim 1, wherein the processor is further configured to:
in response to identifying the second status indicator associated with the second request servicing stage includes the most recent service initiated status, predict a latency value associated with the wireless interaction request based on one or more network parameters associated with the second application server;
compare the latency value with a threshold value and determine if the latency value exceeds the threshold value; and
in response to determining that the latency value exceeds the threshold value, generate the transformed interaction request.

3. The system of claim 1, wherein the processor is further configured to:
store a cluster of artificial intelligence (AI) algorithms, wherein the cluster of AI algorithms includes a first AI algorithm and a second AI algorithm;
determine, by executing the first AI algorithm, if the wireless interaction request is a critical request based on the extracted interaction identifier; and
in response to determining that the wireless interaction request is the critical request based on the extracted interaction identifier, predict a latency value associated with the wireless interaction request based on one or more network parameters associated with the second application server, wherein the prediction of the latency value is performed by executing the second AI algorithm.

4. The system of claim 2, wherein the one or more network parameters comprises a threshold downtime, a network congestion capacity, or a packet loss rate.

5. The system of claim 1, wherein the first request servicing stage includes a first web server to service the wireless interaction request and the second request servicing stage includes a second web server to service the wireless interaction request.

6. The system of claim 1, wherein the first request servicing stage includes a first file server to service the wireless interaction request and the second request servicing stage includes a second file server to service the wireless interaction request.

7. The system of claim 1, wherein the processor is further configured to:
in response to determining that the wireless interaction request is not the critical request based on the extracted interaction identifier, electronically transmit an interaction failure notification to the user device, wherein the interaction failure notification indicates that the wireless interaction request is not completed.

8. A method comprising:
electronically receiving, from a user device, a wireless interaction request initiated at the user device, wherein the wireless interaction request includes an interaction identifier;
accessing, from a memory, one or more request servicing stages used to complete the wireless interaction request initiated at the user device, wherein the one or more request servicing stages comprises a first request servicing stage and a second request servicing stage, and wherein the first request servicing stage includes a first application server to service the wireless interaction request and the second request servicing stage includes a second application server to service the wireless interaction request;
electronically transmitting the wireless interaction request to the first request servicing stage to initiate servicing the wireless interaction request by the first application server and store a copy of the wireless interaction request in a request tracking database;
in conjunction with electronically transmitting the wireless interaction request to the first request servicing stage, synchronizing the request tracking database to reflect a current status of the one or more request servicing stages by including a first service initiated status corresponding with a first status indicator of the first request servicing stage;
electronically receiving a synchronization request, from the first application server, to synchronize the current status of the one or more request servicing stages of the request tracking database by updating the first service initiated status of the first status indicator to a first service completed status indicating servicing of the wireless interaction request is completed at the first request servicing stage by the first application server, and by including a second service initiated status corresponding with a second status indicator of the second request servicing stage, wherein the wireless interaction request is transmitted to the second request servicing stage in response to completing the servicing of the wireless interaction request at the first request servicing stage by the first application server;
determining if the wireless interaction request was transmitted successfully to the second application server associated with the second request servicing stage;
in response to determining that the wireless interaction request was not transmitted successfully to the second application server, extracting the interaction identifier from the copy of the wireless interaction request stored in the request tracking database;
determining if the wireless interaction request is a critical request based on the extracted interaction identifier;
in response to determining that the wireless interaction request is the critical request based on the extracted interaction identifier, identifying a request servicing stage that includes a most recent service initiated status from the one or more request servicing stages, wherein the second status indicator associated with the second request servicing stage includes the most recent service initiated status;
in response to identifying the second request servicing stage to include the most recent service initiated status, identifying an edge application server that performs one or more functions associated with the second application server associated with the second request servicing stage;
modifying the copy of the wireless interaction request to include a destination address corresponding with the edge application server to generate a transformed interaction request;
electronically transmitting the transformed interaction request to the edge application server; and
in response to electronically transmitting the transformed interaction request to the edge application server, receiving an interaction completed notification from the edge application server, wherein the interaction completed notification indicates that the wireless interaction request initiated at the user device is completed.

9. The method of claim 8, further comprising:
in response to identifying the second status indicator associated with the second request servicing stage includes the most recent service initiated status, predicting a latency value associated with the wireless interaction request based on one or more network parameters associated with the second application server;
comparing the latency value with a threshold value and determine if the latency value exceeds the threshold value; and
in response to determining that the latency value exceeds the threshold value, generating the transformed interaction request.

10. The method of claim 8, further comprising:
storing a cluster of artificial intelligence (AI) algorithms, wherein the cluster of AI algorithms includes a first AI algorithm and a second AI algorithm;
determining, by executing the first AI algorithm, if the wireless interaction request is a critical request based on the extracted interaction identifier; and
in response to determining that the wireless interaction request is the critical request based on the extracted interaction identifier, predicting a latency value associated with the wireless interaction request based on one or more network parameters associated with the second application server, wherein the prediction of the latency value is performed by executing the second AI algorithm.

11. The method of claim 9, wherein the one or more network parameters comprises a threshold downtime, a network congestion capacity, or a packet loss rate.

12. The method of claim 8, wherein the first request servicing stage includes a first web server to service the wireless interaction request and the second request servicing stage includes a second web server to service the wireless interaction request.

13. The method of claim 8, wherein the first request servicing stage includes a first file server to service the wireless interaction request and the second request servicing stage includes a second file server to service the wireless interaction request.

14. The method of claim 8, further comprising:
in response to determining that the wireless interaction request is not the critical request based on the extracted interaction identifier, electronically transmitting an interaction failure notification to the user device, wherein the interaction failure notification indicates that the wireless interaction request is not completed.

15. A non-transitory computer-readable medium storing instructions that, when executed by a processor, cause the processor to:
electronically receive, from a user device, a wireless interaction request initiated at the user device, wherein the wireless interaction request includes an interaction identifier;
access, from a memory, one or more request servicing stages used to complete the wireless interaction request initiated at the user device, wherein the one or more request servicing stages comprises a first request servicing stage and a second request servicing stage, and wherein the first request servicing stage includes a first application server to service the wireless interaction request and the second request servicing stage includes a second application server to service the wireless interaction request;
electronically transmit the wireless interaction request to the first request servicing stage to initiate servicing the wireless interaction request by the first application server and store a copy of the wireless interaction request in a request tracking database;
in conjunction with electronically transmitting the wireless interaction request to the first request servicing stage, synchronize the request tracking database to reflect a current status of the one or more request servicing stages by including a first service initiated status corresponding with a first status indicator of the first request servicing stage;
electronically receive a synchronization request, from the first application server, to synchronize the current status of the one or more request servicing stages of the request tracking database by updating the first service initiated status of the first status indicator to a first service completed status indicating servicing of the wireless interaction request is completed at the first request servicing stage by the first application server, and by including a second service initiated status corresponding with a second status indicator of the second request servicing stage, wherein the wireless interaction request is transmitted to the second request servicing stage in response to completing the servicing of the wireless interaction request at the first request servicing stage by the first application server;
determine if the wireless interaction request was transmitted successfully to the second application server associated with the second request servicing stage;
in response to determining that the wireless interaction request was not transmitted successfully to the second application server, extract the interaction identifier from the copy of the wireless interaction request stored in the request tracking database;
determine if the wireless interaction request is a critical request based on the extracted interaction identifier;
in response to determining that the wireless interaction request is the critical request based on the extracted interaction identifier, identify a request servicing stage that includes a most recent service initiated status from the one or more request servicing stages, wherein the second status indicator associated with the second request servicing stage includes the most recent service initiated status;
in response to identifying the second request servicing stage to include the most recent service initiated status, identify an edge application server that performs one or more functions associated with the second application server associated with the second request servicing stage;
modify the copy of the wireless interaction request to include a destination address corresponding with the edge application server to generate a transformed interaction request;
electronically transmit the transformed interaction request to the edge application server; and
in response to electronically transmitting the transformed interaction request to the edge application server, receive an interaction completed notification from the edge application server, wherein the interaction completed notification indicates that the wireless interaction request initiated at the user device is completed.

16. The non-transitory computer-readable medium of claim 15, wherein the instructions further cause the processor to:
in response to identifying the second status indicator associated with the second request servicing stage includes the most recent service initiated status, predict a latency value associated with the wireless interaction request based on one or more network parameters associated with the second application server;
compare the latency value with a threshold value and determine if the latency value exceeds the threshold value; and
in response to determining that the latency value exceeds the threshold value, generate the transformed interaction request.

17. The non-transitory computer-readable medium of claim 15, wherein the instructions further cause the processor to:
store a cluster of artificial intelligence (AI) algorithms, wherein the cluster of AI algorithms includes a first AI algorithm and a second AI algorithm;
determine, by executing the first AI algorithm, if the wireless interaction request is a critical request based on the extracted interaction identifier; and
in response to determining that the wireless interaction request is the critical request based on the extracted interaction identifier, predict a latency value associated with the wireless interaction request based on one or more network parameters associated with the second application server, wherein the prediction of the latency value is performed by executing the second AI algorithm.

18. The non-transitory computer-readable medium of claim 16, wherein the one or more network parameters comprises a threshold downtime, a network congestion capacity, or a packet loss rate.

19. The non-transitory computer-readable medium of claim 15, wherein the first request servicing stage includes a first web server to service the wireless interaction request and the second request servicing stage includes a second web server to service the wireless interaction request.

20. The non-transitory computer-readable medium of claim 15, wherein the first request servicing stage includes a first file server to service the wireless interaction request and the second request servicing stage includes a second file server to service the wireless interaction request.
